(19) United States
(12) Patent Application Publication
(10) Pub. No.: US 2008/0224420 A1
(43) Pub. Date: Sep. 18, 2008

(54) Resilient Sealing Sleeve

(75) Inventor: Anders Egholm Hansen, Koge (DK)

Correspondence Address: WILLIAM J. SAPONE;COLEMAN SUDOL SAPONE P.C., 714 COLORADO AVENUE, BRIDGE PORT, CT, 06605, US

(73) Assignee: CODAN TECH A/S, Koge (DK)

(21) Appl. No.: 10/597,478

(22) PCT Filed: Jan. 25, 2005
(86) PCT No.: PCT/DK05/00051

§ 371 Date: Nov. 20, 2006

(30) Foreign Application Priority Data
Feb. 6, 2004 (DK) PA 2004 00183

(51) Int. Cl. F16J 15/32

(52) U.S. Cl. 277/634

(57) ABSTRACT

When, according to the invention, a sealing sleeve is made of HNBR polymer and is provided with a bushing (3) which extends around the outwardly extending shaft (1), and also with an end portion (6) which may be bellows-shaped and finally an outer ring (7) which can engage the exterior of the shaft housing (6), a solid and tight sleeve is achieved.

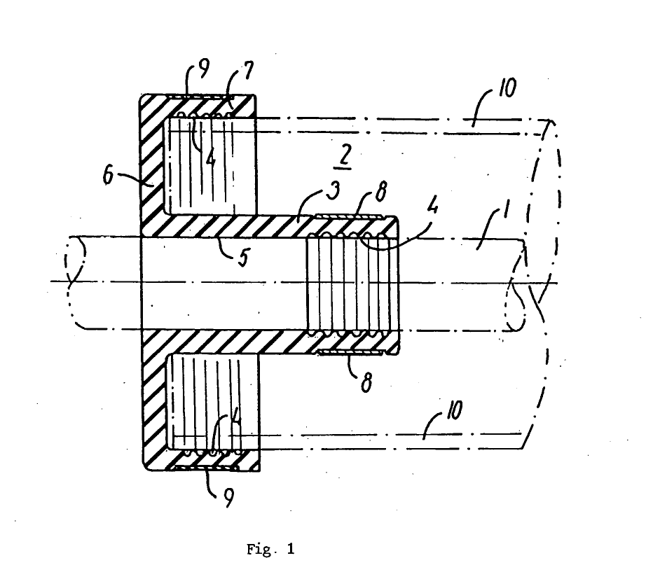

### STATE OF THE ART

The invention relates to a resilient sleeve preferably for sealing around shafts, rods and similar connecting means, said sleeve extending around the shaft and being secured around the shaft and optionally also around the exterior of the housing or shield extending around the shaft.

Such sealing sleeves are known in numerous embodiments. Because of the increased requirements with respect to such products, particularly in the automobile industry, everything technically possible has been done to configure the sleeves to meet the requirements.

In particular, the sleeves must be capable of withstanding the mechanical impacts to which they are subjected in operation, which especially involves vibrations and the ability to absorb movements. In addition, the sleeves must be capable of accommodating angular movements, where universal joints and the like are involved.

In this connection, previously known rubber sleeves have the drawback that ageing especially causes the elasticity of the rubber to deteriorate, just as cracks and fissures easily occur.

Another purpose of the sleeves is that they must be capable of withstanding the impacts from the lubricants, particularly such as are aggressive, and the rubber sleeves must have a great thickness to be able to withstand these impacts.

US 2002/132674 A discloses an example of a sleeve made of polyurethane foam which, however, cannot satisfy the wear resistance and sealing requirements of today.

The reason is the material which is not sufficiently gas-tight and wear resistant.

To this should be added that the seal around the shaft is not very reliable owing to the completely smooth engagement face.

U.S. Pat. No. 3,854,733 discloses a sealing ring which is provided with ribs for sealing which extend internally as well as externally. No particularly high degree of sealing is involved, however, since the sealing part is so relatively small that the sealing degree around the shaft will be very limited. To this should be added that wear will rapidly reduce the tightness.

### OBJECT OF THE INVENTION

The object of the invention is to remedy these drawbacks, and this is achieved according to the invention in that the face of the bushing extending toward the shaft is provided with ribs, waves in about one half of the length of the bushing to seal around the shaft.

An effective seal is achieved in this simple manner in the mounting of the sleeve around the parts at the location for the mounting, as the ribs, the waves at the engagement face will ensure a completely tight joint through which lubricants cannot escape, and where liquids cannot penetrate from the outside, just as the wear resistance is great.

When, as stated in claim 2, the ribs, the waves are arranged near the inner end of the bushing, a great wear resistance as well as sealing degree will be achieved.

When, as stated in claim 3, the sleeves are made of a piece of HNBR polymer, the ability of the sleeve to maintain the elasticity and its resistance to aggressive agents, such as lubricants, salts and like, as well as a high degree of gas tightness are ensured.

Finally, it is expedient, as stated in claim 4, to add fibres, preferably made from phenols, to the material, since its tensile strength is increased hereby.

### THE DRAWING

An embodiment of a sleeve according to the invention will be described more fully below with reference to the drawing, which shows a sectional view of a sleeve mounted around a shaft in a housing.

### DESCRIPTION OF THE EMBODIMENT

The embodiment shown in the drawing comprises a structure comprising a shaft 1 which extends inside a housing 10, 2 with lubricants, and where a sealing sleeve according to the invention surrounds the shaft 1 and the end face of the housing 10.

Interiorly, the sleeve comprises a bushing 3 which engages the shaft 1, and which is of such a length that a strap 8 or the like can easily be mounted.

The engagement face may be provided with ribs or waves 4, which gives an effective seal against “creeping” lubricant, if any, from the interior 2 of the housing and out.

At the end, the sleeve merges into an end wall 6 which is flat in the example shown, but which may be bellows-shaped or pleated, as needed, to accommodate angular deflections.

Finally, a ring portion 7 is provided externally on the sleeve, said ring portion engaging the housing or shield 10 which surrounds the shaft 1.

The extent of this ring portion 7 is such as to allow clamping by means of a strap 9 or the like.

Further, the internal side may also be provided with ribs, waves 4 to seal against leakage of lubricant via the housing 10.

The sleeve is preferably made of HNBR polymer, hydrated nitrile butadiene, optionally together with generally known composite materials, which material has been found to have ideal properties for use in sealing sleeves of this type. A preferred additive is fibres made from phenols, since the tensile strength of the material is increased hereby.

The material is suitable for moulding the sleeve in a tool directly around the shaft, as the material is very stable dimensionally.

Conclusively, it may be said that the material has great wear resistance and good elasticity properties,

a high temperature resistance in the range of −40° C. to 150° C., thereby obviating the use of heat shields in the structure,
a high rate to meet ASTM No. 1, viz. 168 h at 150° C. with an oil leakage of max 3%, and finally the material can resist aggressive lubricants in the form of grease and oil.

1. A resilient sleeve preferably for sealing around shafts, rods and similar connecting means, said sleeve extending around the shaft and being secured around the shaft and optionally also around the exterior of the housing or shield extending around the shaft, characterized in that the face of the bushing (3) extending toward the shaft (1) is provided with ribs, waves (4) in about one half of the length of the bushing (3) to seal around the shaft (1).

2. A resilient sleeve according to claim 1, characterized in that the ribs, the waves (4) extend near the inner end of the bushing (3).

3. A resilient sleeve according to claims 1 and 2, characterized in that the sleeve is made of a piece of HNBR polymer and optionally with generally known additives.

4. A resilient sleeve according to claim 3, characterized in that the additive comprises fibres preferably from phenols.
